(19) United States
(12) Patent Application Publication
(10) Pub. No.: US 2007/0169314 A1
(43) Pub. Date: Jul. 26, 2007

(54) Rotating shaft structure

(75) Inventors: Wang-Jui Lee, Sinjhuang City (TW); Chin-Chung Huang, Sinjhuang City (TW); Feng-Yu Chung, Sinjhuang City (TW); Chia-Cheng Chen, Sinjhuang City (TW)

Correspondence Address: John G. Chupa;Law Offices of John Chupa & Associates, P.C., Suite 50, 28535 Orchard Lake Road, Farmington Hills, MI, 48334, US

(73) Assignee: JARLLYTEC CO., LTD.

(21) Appl. No.: 11/545,374

(22) Filed: Oct. 10, 2006

(30) Foreign Application Priority Data
Jan. 5, 2006 (TW) 095200213

(51) Int. Cl. E05D 11/08

(52) U.S. Cl. 16/342

(57) ABSTRACT

The present invention discloses a rotating shaft structure, comprising a fixed part having a connecting portion whose one end extends to form an external sleeve, wherein the external sleeve is cut to form an shaft hole which is axially communicatable with an embedded groove along whose perpendicular direction which is cut to form a connecting groove; an hollow inner bushing which is partitioned at least by a cut groove into at least two clamping rings whose one end extends radially to form a frame plate and the other end forms a opening with the frame plate, wherein at least a connecting plate is protrudingly disposed on one side of the frame plate; and a moving part having a linking portion on one end and a shaft extending axially from the other end, such that when the inner bushing is socketingly connected within the external sleeve, the clamping rings, the frame plate, and the connecting plate are positioned in the shaft hole, the embedded groove, and the connecting groove, respectively to form a firm connection, and the shaft is embeddedly inserted in the clamping ring in a tight fit.

### FIELD OF THE INVENTION

The present invention relates to a rotating shaft structure and in particular to a rotating shaft structure disposed with an inner bushing which may firmly connected into an external sleeve of a fixed part, such that when the moving part rotates, a stable frictional torque may be generated.

### BACKGROUND OF THE INVENTION

Consumer electronics with flip covers, such as portable computer, electronic dictionary, portable audio/video player, flip mobile phone, generally have a main body on the bottom, which is pivotally connected with the cover body on the top, such that the cover body may swing open or close with respect to the main body. Consequently, the rotating shaft is key to the quality of the products described above. In fact, the design for a good rotating shaft shall not only demand a necessary arresting effect to prevent loose joint after repetitive operations, but also prevent abnormal sound from occurring to annoy users.

For a traditional socket-joint rotating shaft to achieve a high precision of arresting function for positioning, it is usually to form a shaft hole on the female connecting part and a cut groove horizontally on the shaft of the male connecting part, such that the shaft is provided with a certain extent of elasticity to insert into the shaft hole and thus a frictional torque is generated between the shaft and the shaft hole. Because the cut groove on the aforementioned shaft, the friction section of the shaft on the shaft hole is at the location between the both ends of the cut groove and the direction of the frictional torque is perpendicular to the cut groove. Consequently, the two frictional sections wear significantly after repetitive uses, leading to a loose joint.

To resolve the shortcomings of the aforementioned socket-joint rotating shaft, companies have developed a pivotal device completely different from the aforementioned technology. ROC Patent M248214 and M265898, for example, disclose a fixed seat axially cut to form a connecting hole which is connected to an communicatable groove and is disposed with a plurality of spring coil frames therein, wherein an axially protruding plate is inserted into the groove and a pivotally rotating shaft is embeddedly inserted into the hole of the spring coil frame for rotating therein, such that the spring coil frame generates a frictional torque with respect to the rotating shaft. Although the pivotal device may obtain the expected arresting function, one major shortcoming of the design is that the inclusion of a plurality of spring coil frames, which complicate the assembling operation. Furthermore, the groove communicatable with the connecting hole is insertingly connected within the protruding plate of the spring coil frame, and thus, when the rotating shaft rotates, only the left-and-right, but not the up-and-down, jitter of the spring coil frame can be avoided. Consequently, it is necessary to design a new rotating shaft structure to overcome the shortcomings described above.

### SUMMARY OF THE INVENTION

With long time experience in designing, production, and marketing of rotating shaft, the applicant proposes the present “Rotating Shaft Structure” after numerous experiments and testings in order to overcome aforementioned drawbacks of conventional prior art.

An object of the present invention is to provide a rotating shaft structure, comprising a fixed part having a connecting portion whose one end extends to form an external sleeve, wherein the external sleeve is cut to form an shaft hole which is axially communicatable with an embedded groove along whose perpendicular direction which is cut to form a connecting groove; an hollow inner bushing which is partitioned at least by a cut groove into at least two clamping rings whose one end extends radially to form a frame plate and the other end forms a opening with the frame plate, wherein at least a connecting plate is protrudingly disposed on one side of the frame plate; and a moving part having a linking portion on one end and a shaft extending axially from the other end, such that when the inner bushing is socketingly connected within the external sleeve, the clamping rings, the frame plate, and the connecting plate are positioned in the shaft hole, the embedded groove, and the connecting groove, respectively to form a firm connection, and the shaft is embeddedly inserted in the clamping ring in a tight fit.

Another object of the present invention is to provide a rotating shaft structure, wherein the connecting portion of the fixed part or the linking portion of the moving part is disposed with at least a connecting hole, and further the connecting portion of the fixed part or the linking portion of the moving part is a mill-face prism or a polyhedron.

Yet another object of the present invention is to provide a rotating shaft structure, wherein the external wall of the external sleeve is cut to form a through hole and the inner bushing is cut to form a plate hole at the location corresponding to the connecting plate, such that a connecting device can be put through and fastened.

Still yet another object of the present invention is to provide a rotating shaft structure, wherein the openings of the at least two clamping rings may face the same or opposite direction.

Still another object of the present invention is to provide a rotating shaft structure, wherein the surface of the shaft is arranged with a curved oil groove, and further the front edge of the shaft is provided with a chamfered portion.

### BRIEF DESCRIPTION OF THE DRAWINGS

The present invention can be more fully understood by reference to the following description and accompanying drawings, in which:

FIG. 1 schematically illustrates an exploded perspective view of a rotating shaft structure according to the present invention;

FIG. 2 schematically illustrates a cross-sectional view of a rotating shaft structure after assembly according to the present invention;

FIG. 3 schematically illustrates another cross-sectional view of a rotating shaft structure after assembly according to the present invention; and

FIG. 4 schematically illustrates a perspective view of a rotating shaft structure after assembly according to the present invention

### DETAILED DESCRIPTION OF THE INVENTION

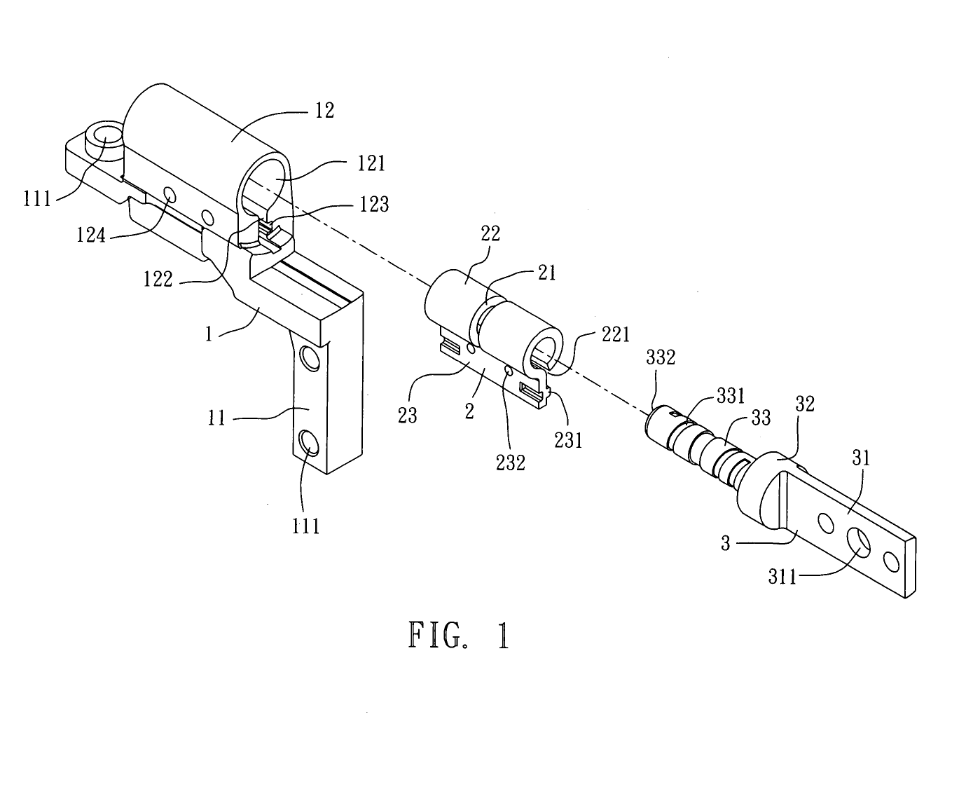

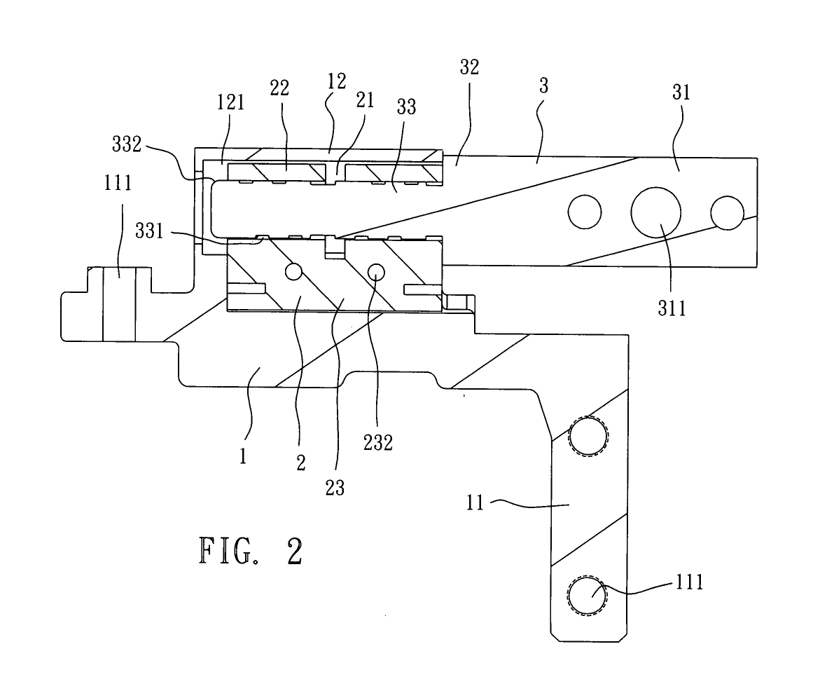

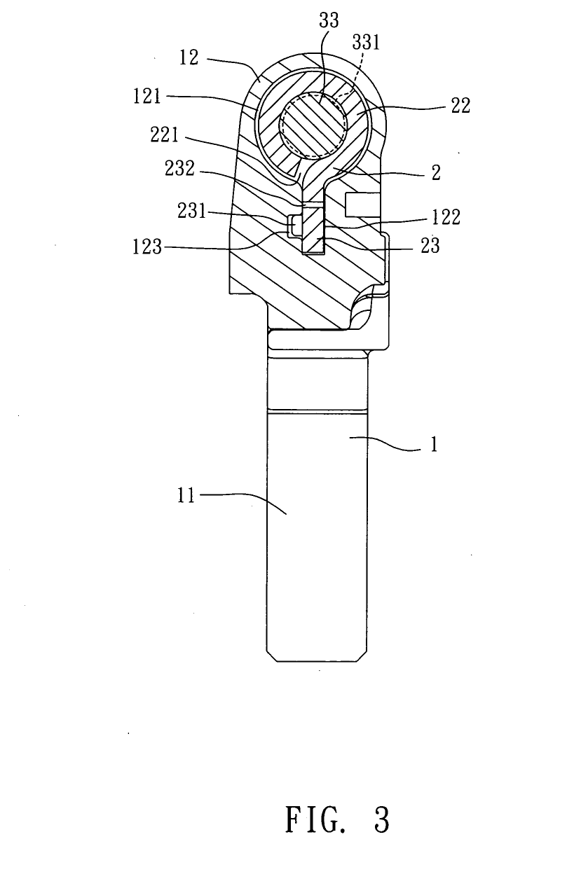

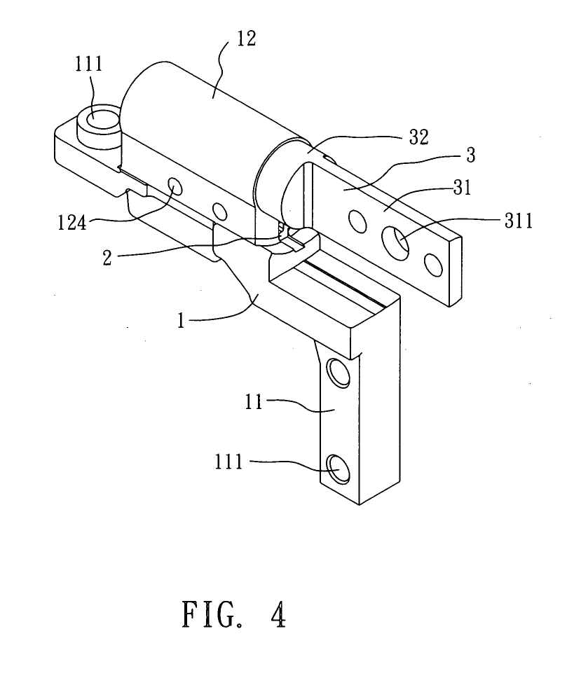

Referring to FIGS. 1 to 4, a rotating shaft structure according to the present invention comprises a fixed part 1, an inner bushing 2, and a moving part 3, wherein the “fixed” and “moving” do not limit the motion of the aforementioned parts. When the present invention is put into practice, the moving part 3 may also be in retaining status, whereas the fixed part 1 may rotate.

The fixed part 1 is a frame having a connecting portion 11 to connect with an object, a main body for example. The connecting portion 11 shown in the figures includes at least a connecting hole 111, into which a conventional connecting device, for example but not limited to a screw, may be put through to fasten an object. The connecting portion 11 may be a mill-face prism or a polyhedron, for example, a triangular prism, a quadratic prism, and so on, so as to embeddedly insert and locate the object.

One side of the connecting portion 11 extends to form an external sleeve 12 which is cut to form an shaft hole 121 and the shaft hole 121 is axially communicatable with an embedded groove 122. The characteristic of the present invention is that the center portion of the embedded groove 122 is cut to form a connecting groove 123 along its perpendicular direction. Further, to fasten the inner bushing 2 onto the external sleeve 12, the embedded groove 122 is cut to form a through hole 124 toward the external wall of the external sleeve 12, such that a conventional connecting device, a screw for example, may put through therein.

The inner bushing 2 is a hollow cylinder which is partitioned at least by a cut groove 21 into at least two clamping rings 22 which are formed by bending and whose one end extends radially to form a frame plate 23 and the other end forms a opening 221 with the frame plate 23, such that the clamping ring 22 may expand or contract elastically. To provide different torques, as shown in the figures, the opening 221 of the two clamping rings 22 may face the same or opposite direction. The characteristic of the present invention is that at least a connecting plate 231 is protrudingly disposed on one side of the frame plate. As shown in the figures, two ends of one side of the frame plate 23 are stamped to form two protruding connecting plates 231 on the opposite side, such that the through holes 124 correspond to a plate hole 232, respectively, for the passing of a connecting device.

The moving part 3 is a rod having a linking portion 31 on one end to connect with another object, a cover body for example, as shown in the figures, and the linking portion 31 is cut to form at least a connecting hole 311, into which a conventional connecting device, for example but not limited to a screw, may be put through to fasten an object. The connecting portion 31 may be a mill-face prism or a polyhedron, for example, a triangular prism, a quadratic prism, and so on, so as to embeddedly insert and locate the object.

The edge of the linking portion 31 is disposed a shaft collar 32, which is abutted against the external sleeve 1 when being assembled. The shaft collar 32 axially extends a shaft 33 whose surface is arranged with a curved oil groove for receiving lubricant and thus providing lubrication. Further, the front edge of the shaft 33 is provided with a chamfered portion 332 so as to facilitate the embedded insertion of the shaft into the clamping ring 22.

When the present invention is being assembled, the connecting plate 231 of the inner bushing 2 is first aligned along with and inserted into the connecting groove 123, such that the clamping ring 22 and frame plate 23 are socketingly connected within the shaft hole 121 and the embedded groove 122 of the external sleeve 12, respectively, and then a connecting device, a screw for example, may be put through the through hole 124 and the plate hole 232 to securingly fasten and engage the inner bushing 2 within the external sleeve 12. Meanwhile, the shaft 33 is embeddedly inserted within the clamping ring 22 in a tight fit to complete the assembly. When the present invention is being operated, the connecting portion 11 of the fixed part 1 and the linking portion 31 of the moving part 3 are engaged with the main body and the cover body, respectively.

The advantage of the present invention is that the inner bushing is integrally formed, rather than arranged in stages, leading to a decrease in the number of parts and simplification of the assembling process. Further, the frame plate according to the present invention is embeddedly inserted into the embedded groove to prevent the clamping rings from jittering left and right; also, the perpendicular connecting plate is retained in the connecting groove to ensure the clamping rings free from jittering up and down, such that a firm engagement is obtained and thus when the moving part rotates, a stable frictional torque may be generated. Further, the shaft is arranged with a curved oil groove for receiving lubricant and thus providing overall lubrication to avoid abnormal noise during operation, making it the most promising one of its kind.

While the invention has been described with reference to the a preferred embodiment thereof, it is to be understood that modifications or variations may be easily made without departing from the spirit of this invention, which is defined by the appended claims.

What is claimed is:

1. A rotating shaft structure, comprising:
a fixed part having a connecting portion whose one end extends to form an external sleeve, wherein the external sleeve is cut to form an shaft hole which is axially communicatable with an embedded groove along whose perpendicular direction which is cut to form a connecting groove;
an hollow inner bushing which is partitioned at least by a cut groove into at least two clamping rings whose one end extends radially to form a frame plate and the other end forms a opening with the frame plate, wherein at least a connecting plate is protrudingly disposed on one side of the frame plate; and
a moving part having a linking portion on one end and a shaft extending axially from the other end;
such that when the inner bushing is socketingly connected within the external sleeve, the clamping rings, the frame plate, and the connecting plate are positioned in the shaft hole, the embedded groove, and the connecting groove, respectively to form a firm connection, and the shaft is embeddedly inserted in the clamping ring in a tight fit.

2. The rotating shaft structure according to claim 1, wherein the connecting portion of the fixed part or the linking portion of the moving part is disposed with at least a connecting hole.

3. The rotating shaft structure according to claim 1, wherein the connecting portion of the fixed part or the linking portion of the moving part is a mill-face prism or a polyhedron

4. The rotating shaft structure according to claim 1, wherein the external wall of the external sleeve is cut to form a through hole and the inner bushing is cut to form a plate hole at the location corresponding to the connecting plate, such that a connecting device can be put through and fastened.

5. The rotating shaft structure according to claim 1, wherein the openings of the at least two clamping rings may face the same or opposite direction.

6. The rotating shaft structure according to claim 1, wherein the surface of the shaft is arranged with a curved oil groove.

7. The rotating shaft structure according to claim 1, wherein the front edge of the shaft is provided with a chamfered portion.

8. The rotating shaft structure according to claim 1, wherein two ends of one side of the frame plate are stamped to form two protruding connecting plates on the opposite side.
